(19) United States
(12) Patent Application Publication
(10) Pub. No.: US 2019/0219329 A1
(43) Pub. Date: Jul. 18, 2019

(54) FOAM DRYER

(71) Applicant: Worthen Industries, Nashua, NH (US)

(72) Inventors: Robert J. Rose, Richmond, VA (US); Andrew T. Sinclair, Richmond, VA (US)

(21) Appl. No.: 15/871,380

(22) Filed: Jan. 15, 2018

(51) Int. Cl. F26B 3/28; F26B 3/30; F26B 9/06

(52) U.S. Cl. CPC F26B 3/283; F26B 25/063; F26B 9/066; F26B 3/30

(57) ABSTRACT

A device for drying foam pieces is provided. The device uses a combination of heating and air convection to drive moisture or other solvents and volatile compounds from the adhesive, causing it to rapidly dry. The device for drying foam pieces has a frame that defines a cavity. Foam pieces may be placed in the cavity to be dried. A heater is positioned to direct heat to an item within the cavity. An air blower is configured to draw air into the cavity and expel it from an outlet.

### BACKGROUND OF THE INVENTION

### Field of the Invention

The present invention relates generally to foam drying devices. More particularly the present invention relates to a system which draws air over/through a foam piece having adhesive on or in it as well as heating the foam. This combination of air flow and heat dries the adhesive rapidly.

### Description of Related Art

When assembling foam pieces using adhesives, time must be spent allowing the adhesive to dry. Such foam pieces include, but are not limited to foam assemblies having multiple pieces of foam adhered together, a single foam piece adhered to itself, a foam piece having a material adhered to its exterior, and the like. Often this drying is done by allowing the foam pieces to rest under ambient conditions before packaging. This takes time, and as a result slows down the manufacturing process.

Therefore, what is needed is a device that may increase the speed of the drying/curing of adhesives.

### SUMMARY OF THE INVENTION

The subject matter of this application may involve, in some cases, interrelated products, alternative solutions to a particular problem, and/or a plurality of different uses of a single system or article.

In one aspect, a foam dryer assembly is provided. The foam dryer assembly is formed by a frame which defines a cavity and an opening allowing air to enter the cavity. The cavity is sized and configured to receive a foam piece having a quantity of adhesive on or it in. An air blower is connected to the foam dryer and configured to draw air through the opening into the cavity to be conveyed over and/or through the foam piece. A heater is configured to heat the foam piece when positioned in the cavity.

In another aspect, a foam dryer assembly is provided. In this aspect, the dryer is formed by a frame which defines a cavity and an opening allowing air to enter the cavity. A foam piece comprising foam and a quantity of adhesive is positioned within this cavity. A heater is attached to the frame and configured to direct heat at the foam piece to heat it. An air blower is attached to the frame and configured to draw air through the opening, into the cavity, and through an outlet. In so doing, air is conveyed over and/or through the foam piece, causing the adhesive to rapidly dry (cure, etc.).

### BRIEF DESCRIPTION OF THE DRAWINGS

FIG. 1 provides a front view of an embodiment of the present invention.

FIG. 2 provides a perspective view of another embodiment of the present invention.

FIG. 3 provides a perspective view of yet another embodiment of the present invention.

FIG. 4 provides a side view of still yet another embodiment of the present invention.

FIG. 5 provides a front view of another embodiment of the present invention.

### DETAILED DESCRIPTION

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments.

Generally, the present invention concerns a foam drying system which uses heat and air flow to dry foam pieces which have wet adhesive on or within. The foam dryer has a frame that defines a cavity. Foam pieces may be placed in the cavity to be dried. A heater is positioned to direct heat to an item within the cavity. An air blower is configured to draw air into the cavity and expel it from an outlet. In one embodiment, the foam drying system may only use an air blower. In another embodiment, the foam drying system may only use a heater. However, in most embodiments, a combination of the heater and air blower is used. In other embodiments, the heater and air blower may cycle in alternate operations. In many embodiments, the goal of the present invention is draw generally ambient conditioned air over/through a heated foam piece, though other variations and modes of operation of the present invention are not excluded.

The term adhesive is used herein to refer to both stages of the adhesive: when it is wet and uncured, and when it has dried/cured and is a finished product. The adhesive contemplated herein may be any adhesive capable of being disposed on or in a foam to adhere another material to the foam. Typically, the adhesive is water based, however any other solvent material may also be used in the adhesive. The term “dry” refers to driving off not only water but other solvent content as well, and generally refers to the process of curing the adhesive regardless of adhesive type.

The foam pieces referred to herein may be any foam elements having a quantity of adhesive. For example, the foam piece may be two foam elements adhered together. In another example a foam piece may be a foam element with a fabric or other cover adhered to it. Generally, the foam piece may be any foam with wet adhesive in or on it to be dried.

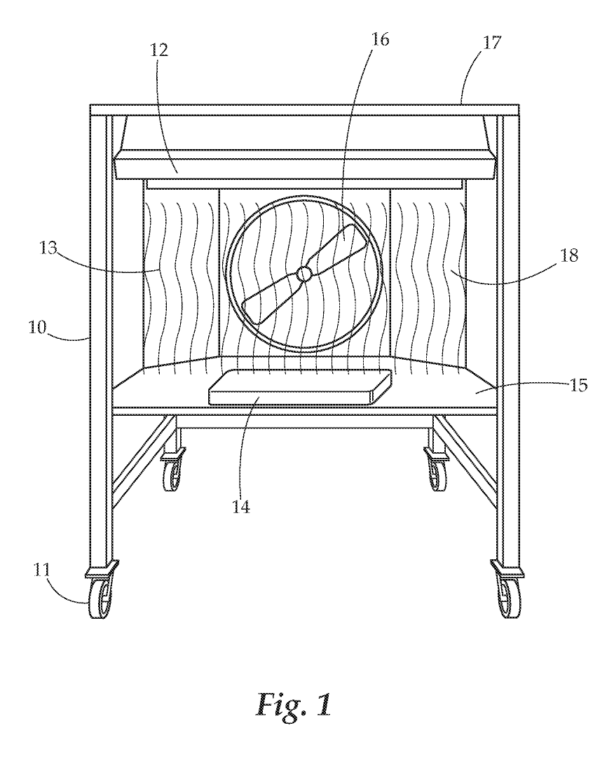

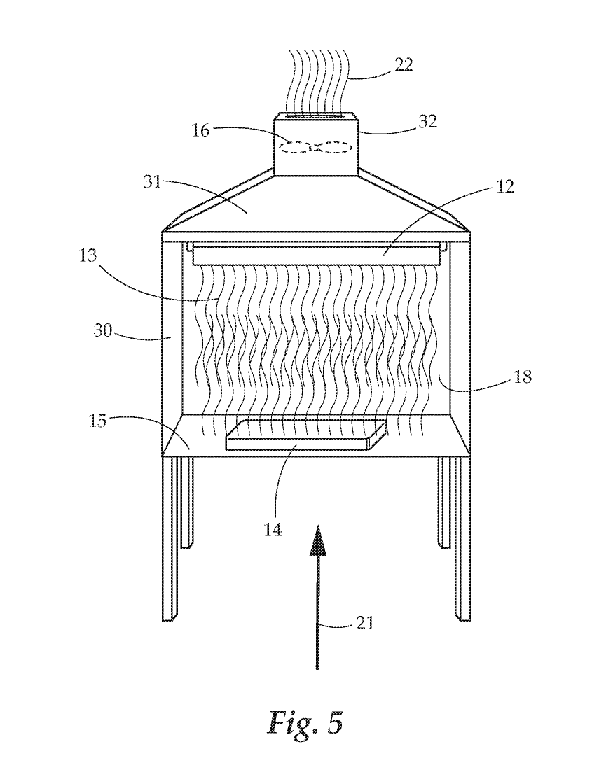

Turning now to FIG. 1, an embodiment of the foam dryer is shown. The foam dryer is formed of a frame 10, which may be any structure or body that provides a base structure for the elements of the foam dryer. A plurality of legs depend from the frame 10 and are connected to casters 11. A cavity 18 is defined in which a foam piece 14 is positioned. The foam piece 14 may rest on the base 15, or may be positioned on a rack (not shown) which elevates the foam piece 14 from the base 15 and allows air to flow over or into a bottom face of the foam piece 14. In another embodiment shown in FIG. 5, the base 15 may be an air permeable structure such as rack or the like. Heater 12 is configured to direct heat towards the foam piece 14 when it is positioned in the cavity 18. In this embodiment, heater 12 is positioned on a top 17 of the foam dryer and directed towards the base 15 of the cavity 18, however other placements and configurations are within the scope of this invention. The heater 12 may be any heater structure. In a particular embodiment, the heater may be a radiant heater. Radiant heaters may be preferable in some embodiments to heat the foam despite air flowing in a direction that is not the same as the heater-to-foam direction. Other heater embodiments (which may or may not also utilize radiant heating mechanisms) include infrared heaters, heating elements, and a microwave heating configuration. An air blower 16 is positioned on a rear of the frame 10 and is configured to draw air into the cavity 18 by an open front and out through a rear of the cavity. However it should be understood that any configuration of the air blower 16 may be used so long as air is conveyed into the cavity 18 and over/through any foam pieces that are positioned within the cavity 18. The air blower 16 may be any structure or configuration so long as air is conveyed into the cavity 18 and over/through any foam pieces that are positioned within the cavity 18. Typically the air blower 16 is some sort of fan or turbine to mechanically encourage air movement. However, passive air conveyors that use other mechanisms such as heated air convection and the like may also be used.

The sizing of the foam dryer may vary without straying from the scope of the present invention. Typically the cavity may be large enough to receive 1-5 foam seat cushions. In one embodiment, foam pieces may range in size from six inches to ten inches in thickness, with lengths and widths ranging between twenty to sixty inches. However, smaller and larger configurations may be utilized. In a particular embodiment, the front opening may be approximately six feet wide and three feet tall. Depending on configuration, the cavity may be of similar size, or may be wider or taller.

In one embodiment, the heat output of the heater may be 3000 Watts. In another embodiment, the heater may be a 208 volt, 3000 Watt electric infrared heater that has a surface temperature of approximately 1,600 F. In another embodiment, the air blower may have a capacity of approximately 2500-3000 CFM. In yet another embodiment, the ratio of heater power to air blower volume flow may be approximately 1.3-0.9 W/CFM. In another embodiment, the ratio of heater power to air blower volume flow may be approximately 1.2-1 W/CFM. Other embodiments may include a closure to partially close off the frame to provide more directed air inlet through an opening. For example, a door may cover a top portion of the opening of FIG. 1, to cause air to enter through a bottom opening closer to where the foam piece is located.

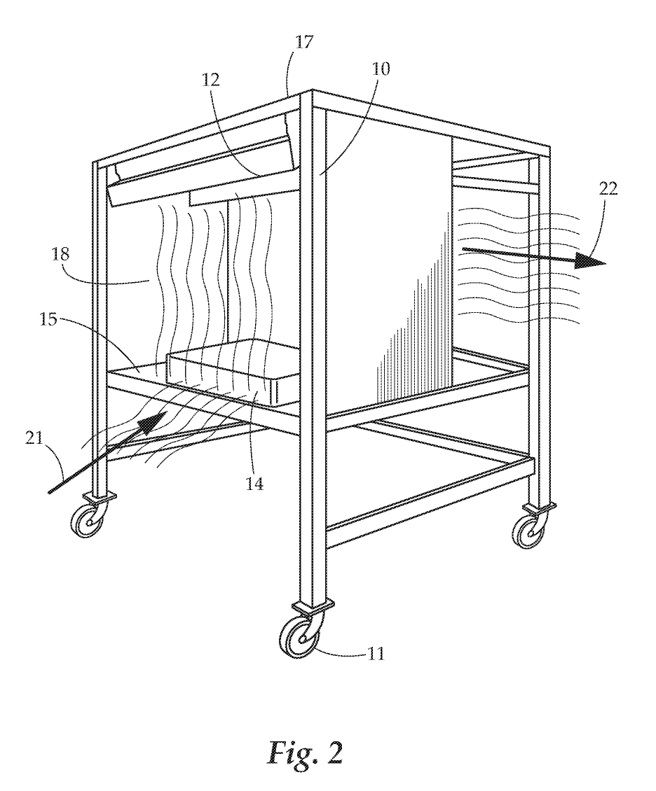

FIG. 2 shows another embodiment of the present invention. In this embodiment, the foam dryer is formed of a frame 10 or similar body which provides a base structure for the elements of the foam dryer. A plurality of legs depend from the frame 10 and are connected to casters 11. A cavity 18 is defined into which a foam piece 14 is positioned. Outside air 21 is drawn into the cavity 18 through the front opening (formed in this embodiment as a open front space surrounded by base 15, top 17 and two side walls) and passes over the foam piece 14. Moisture or solvent vaporizes into the air as it passes by/through the foam piece 14. Heat 13 provided by heater 12 encourages this vaporization by increasing the temperature of the foam piece 14, the inlet air 21 and the surroundings of the foam piece 14. The air blower 16 (not visible in FIG. 2) then expels the air as outlet air 22. In this embodiment, the outlet air 22 is expelled from the rear of the foam dryer. This outlet air 22 contains moisture, solvents, or other volatile compounds that leave the adhesive of the foam piece 14 during the curing process.

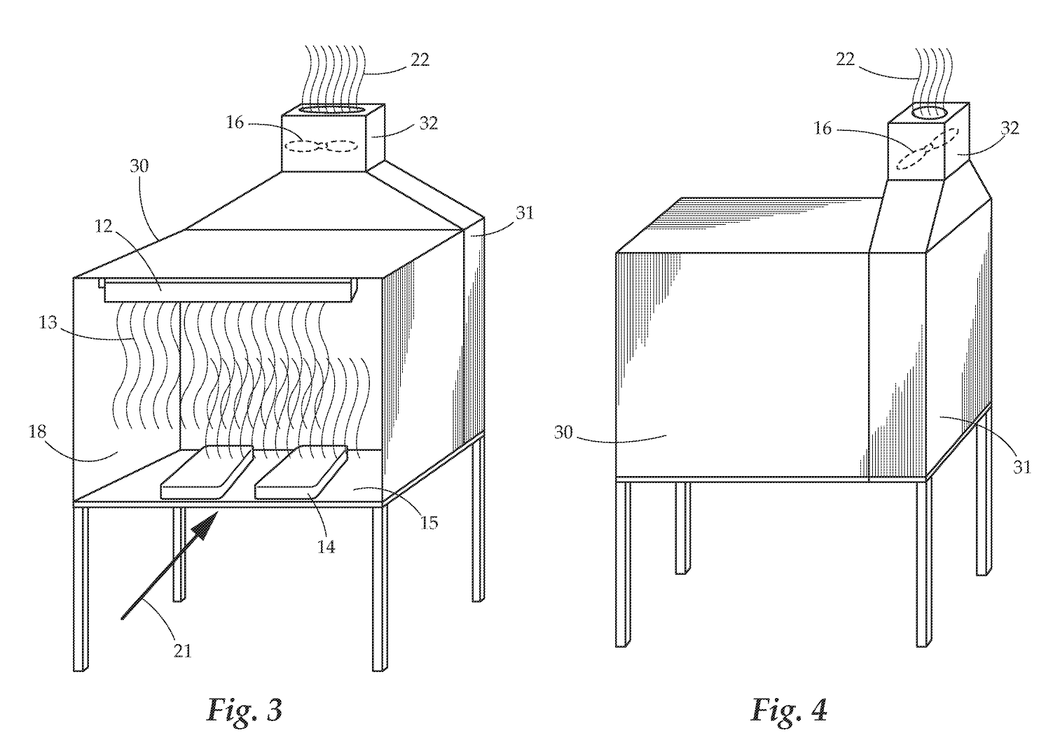

FIGS. 3 and 4 provide perspective and side views of another embodiment of the present invention. In this embodiment, the foam dryer is formed of a frame 10 or similar body which provides a base structure for the elements of the foam dryer. This base structure defines two areas: a dryer section 30 at a front, and an exhaust portion 31 at a rear. A cavity 18 is defined in which a foam piece 14 is positioned. In the dryer section is a heater 12 as well as a cavity 18 for receiving the foam piece 14. Heater 12 directs heat 13 to the foam pieces 14. In this embodiment, foam pieces 14 are resting on the base 15 but as noted above, the foam pieces 14 may be positioned on a rack or similar structure. Inlet air 21 enters the opening in the dryer section causing at least some of the water or solvent of any uncured adhesive in the foam piece to vaporize. The exhaust portion 32 is in communication with the dryer section 31 and may not be structurally separated from it, depending on embodiment. The exhaust portion extends upwardly beyond a top of the dryer section to form an outlet chimney 32. The blower 16 of this embodiment is positioned in this chimney 31. Outlet air 22 exits from a top of the exhaust portion 31. This outlet air 22 contains moisture, solvents, or other volatile compounds that leave the adhesive of the foam piece 14 during the adhesive drying process.

FIG. 5 shows another embodiment of the present invention having an air-permeable base 15. In this view, similar to the other embodiments, inlet air 21 is drawn into cavity 18 by blower 16. In this embodiment, inlet air 21 may enter through the base 15 which is air permeable. The base 15 may be formed of a rack, a perforated base material, and the like. Heater 12 directs heat 13 to the foam pieces 14. In this embodiment, foam pieces 14 are resting on the base 15 but as noted above, the foam pieces 14 may be positioned on a rack or similar structure. Exhaust portion 32 is in communication with the dryer section 31. The exhaust portion extends upwardly beyond a top of the dryer section to form an outlet chimney 32. The blower 16 of this embodiment is positioned in this chimney 31. Outlet air 22 exits from a top of the exhaust portion 31.

While several variations of the present invention have been illustrated by way of example in preferred or particular embodiments, it is apparent that further embodiments could be developed within the spirit and scope of the present invention, or the inventive concept thereof. However, it is to be expressly understood that such modifications and adaptations are within the spirit and scope of the present invention, and are inclusive, but not limited to the following appended claims as set forth.

What is claimed is:

1. A foam dryer assembly comprising:
a frame, the frame defining a cavity and an opening allowing air flow into the cavity;
the cavity configured to receive a foam piece comprising foam and a quantity of adhesive;
an air blower configured to draw air through the opening into the cavity and out of the cavity through an outlet; and
a heater configured to heat the foam piece when received in the cavity.

2. The foam dryer assembly of claim 1 wherein the heater is positioned on a top of the cavity and configured to direct heat downward.

3. The foam dryer assembly of claim 1 wherein the opening is configured as an open front of the frame.

4. The foam dryer assembly of claim 1 wherein the frame comprises an air permeable rack as a bottom surface, the air permeable rack being the opening.

5. The foam dryer assembly of claim 1 wherein the air blower is configured to direct air through the outlet positioned on a top of the frame.

6. The foam dryer assembly of claim 1 wherein the air blower is configured to direct air through the outlet positioned on a rear of the frame.

7. The foam dryer assembly of claim 1 wherein the frame comprises a plurality of legs elevating the frame.

8. The foam dryer assembly of claim 1 further comprising a foam piece positioned in the cavity to receive a heat from the heater and positioned to have an air flow from the air blower pass at least one of over and through it.

9. The foam dryer assembly of claim 1 wherein the frame comprises an exhaust portion, the outlet positioned in the exhaust portion, and wherein the exhaust portion is in communication with the cavity.

10. The foam dryer assembly of claim 1 further comprising a rack in the cavity, the foam piece positioned on the rack.

11. The foam dryer assembly of claim 1 wherein the heater is an infrared heater.

12. The foam dryer assembly of claim 1 wherein the heater is configured to produce heat at a rate of approximately 3000 W.

13. The foam dryer assembly of claim 1 wherein the air blower is configured to convey air at a rate of approximately 2500-3000 CFM.

14. The foam dryer assembly of claim 1 wherein a ratio of a rate of air conveyance of the air blower to heat production of the heater is approximately 1.3-0.9 W/CFM.

15. A foam dryer assembly comprising:
a frame, the frame defining a cavity and an opening configured as an open front of the frame allowing air flow into the cavity;
a foam piece positioned within the cavity, the foam piece comprising foam and a quantity of adhesive;
a heater positioned on a top of the cavity and configured to direct heat downward to the foam positioned in the cavity below the heater; and
an air blower configured to draw air through the opening into the cavity and out of the cavity through an outlet, the air blower configured to draw air over exterior surfaces of the foam piece which are heated by the heater.

16. The foam dryer assembly of claim 15 wherein the heater is configured to produce heat at a rate of approximately 3000 W.

17. The foam dryer assembly of claim 15 wherein the air blower is configured to convey air rate of approximately 2500-3000 CFM.

18. The foam dryer assembly of claim 15 wherein a ratio of a rate of air conveyance of the air blower to heat production of the heater is approximately 1.3-0.9 W/CFM.

19. The foam dryer assembly of claim 15 wherein the frame comprises an exhaust portion, the outlet and the air blower positioned in the exhaust portion, and wherein the exhaust portion is in communication with the cavity.

20. The foam dryer assembly of claim 15 further comprising a rack in the cavity, the foam piece positioned on the rack.
